(19) United States
(12) Patent Application Publication
(10) Pub. No.: US 2003/0087576 A1
(43) Pub. Date: May 8, 2003

(54) Loose fill thermal insulation containing supplemental infrared radiation absorbing material

(75) Inventors: Alain Yang, Bryn Mawr, PA (US); Murray S. Toas, Norristown, PA (US); Michael J. Noone, Wayne, PA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: CERTAINTEED CORPORATION, Valley Forge, PA

(21) Appl. No.: 09/986,275

(22) Filed: Nov. 8, 2001

(51) Int. Cl. D04H 1/00; D04H 3/00; B32B 5/16

(52) U.S. Cl. 442/417

(57) ABSTRACT

A thermal insulation product includes infrared radiation absorbing and scattering material dispersed on a loose fill. The infrared absorbing material can include borates, carbonates, nitrates and nitrites of alkali metals and alkaline earth metals.

### BACKGROUND OF THE INVENTION

1. Field of the Invention

This invention relates to thermal insulation. More specifically, this invention relates to loose fill thermal insulation containing infrared radiation (“IR”) absorbing and scattering material, which reduces radiative heat transfer through the loose fill.

2. Description of Related Art

Thermal insulation for buildings and other structures is available in the form of mats, batts, blankets and loose fill. Mats, batts and blankets are flexible constructions containing various fibers and are generally prefabricated before being brought to a construction site and installed.

In contrast, loose fill thermal insulation includes a large number of discrete fibers, flakes, powders, granules and/or nodules of various materials. The loose fill can be poured or blown into hollow walls or other empty spaces to provide a thermal barrier.

Heat passes between two surfaces having different temperatures by three mechanisms: convection, conduction and radiation. These heat transfer mechanisms are combined in a quantitative measure of heat transfer known as “apparent thermal conductivity.”

Insertion of loose fill thermal insulation in the gap between two surfaces reduces convection as a heat transport mechanism because the insulation slows or stops the circulation of air. Heat transfer by conduction through the loose fill is also minimal. However, many loose fill compositions are transparent in portions of the infrared spectrum. Thus, even when the gap between surfaces has been filled with loose fill thermal insulation, radiation remains as a significant heat transfer mechanism. Typically, radiation can account for 10 to 40% of the heat transferred between surfaces at room (e.g., 24° C.) temperature.

Particle to particle radiative heat transfer is due to absorption, emission and scattering. The amount of radiative heat transfer between loose fill particles due to emission and absorption is dependent on the difference in particle temperatures, with each particle temperature taken to the fourth power.

To reduce radiative heat loss through thermal insulation, a number of approaches have been considered.

U.S. Pat. No. 2,134,340 discloses that multiple reflections of infrared radiation from a powder of an infrared transparent salt, such as calcium fluoride, added to glass fiber insulation can prevent the infrared radiation from penetrating any substantial distance into the insulation.

U.S. Pat. No. 5,633,077 discloses that an insulating material combining certain chiral polymers with fibers can block the passage of infrared radiation through the insulating material.

U.S. Pat. No. 5,932,449 discloses that glass fiber compositions displaying decreased far infrared radiation transmission may be produced from soda-lime borosilicate glasses having a high boron oxide content and a low concentration of alkaline earth metal oxides.

However, these conventional approaches have focused on reducing radiative heat loss through prefabricated fibrous mats, bats, blankets and boards, but have not addressed how to improve the insulation properties of loose fill.

There remains a need for a cost effective loose fill thermal insulation product that can reduce radiative heat loss.

### SUMMARY OF THE INVENTION

A loose fill thermal insulation product is provided in which an IR absorbing and scattering material is dispersed in a loose fill. The IR absorbing and scattering material can be applied to the loose fill before or at the same time as the loose fill is poured or blown into spaces requiring thermal insulation, such as attics and walls. The IR absorbing and scattering material substantially reduces the radiative heat loss through the loose fill thermal insulation. Inclusion of the IR absorbing and scattering material improves the effective wavelength range over which the loose fill absorbs infrared radiation and improves its overall extinction efficiency. The IR absorbing and scattering materials are about as effective as glass fiber in reducing radiative heat loss through a glass fiber loose fill, but they can be much less expensive than glass fiber. Hence, the IR absorbing and scattering material can provide a cost-effective means of improving loose fill thermal insulation.

### BRIEF DESCRIPTION OF THE DRAWINGS

The preferred embodiments of the invention will be described in detail, with reference to the following figures, wherein:

FIGS. 1a-1d show the absorption spectra of silica, glass fiber, calcium carbonate and borax;

FIG. 2 shows a method of applying IR absorbing and scattering material (“IRM”) to loose fill;

FIG. 3 shows a method of applying IR absorbing and scattering material (“IRM”) to loose fill; and

FIG. 4 shows the variation in thermal conductivity (“K-value”) of mixtures of cellulose loose fill and 12 wt % CaCO₃ (based on the mixture) as a function of the particle size of the CaCO₃.

### DETAILED DESCRIPTION OF PREFERRED EMBODIMENTS

The present invention reduces the radiant transmission of heat through a loose fill thermal insulation product by dispersing an IR absorbing and scattering material in the loose fill. Because the IR absorbing and scattering material can be less expensive than the loose fill, the substitution of the IR absorbing and scattering material for some of the loose fill can lead to a significant cost reduction in thermal insulation.

A suitable IR absorbing and scattering material absorbs and scatters infrared radiation with a wavelength in the 4 to 40 μm range. Preferably, the IR absorbing and scattering material absorbs 6-8 μm (1667-1250 cm⁻¹) infrared radiation. The IR absorbing and scattering material can include one or more alkali metal salts or alkaline earth metal salts containing borates, carbonates, nitrates and nitrites. Borates and carbonates are preferred. Suitable borates include lithium borate, sodium borate, potassium borate, magnesium borate, calcium borate, strontium borate and barium borate. Preferably, the borate is sodium borate (i.e., borax, Na₂B₄O₇.5H₂O). Suitable carbonates include lithium carbonate, sodium carbonate, potassium carbonate, magnesium carbonate, calcium carbonate, strontium carbonate and barium carbonate. Preferably, the carbonate is calcium carbonate.

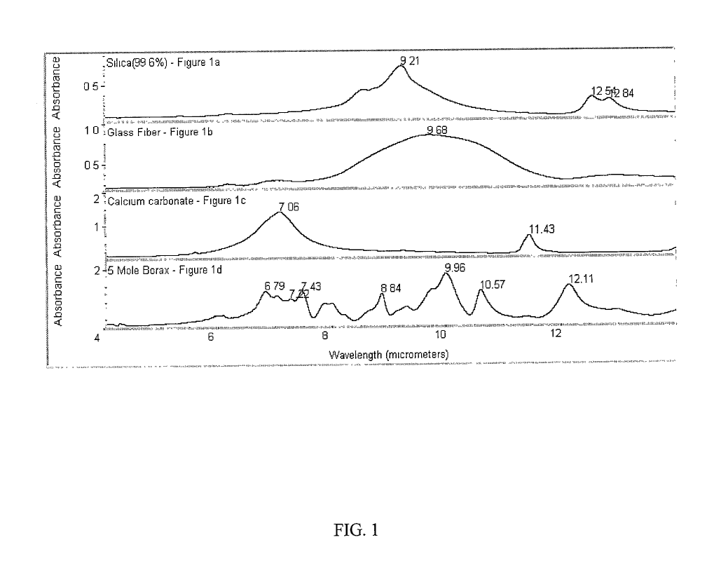

FIGS. 1a-1d show the absorption spectra of, respectively, silica, glass fiber, calcium carbonate and borax. The absorption characteristics of calcium carbonate and borax complement those of silica and glass fiber, which have been used commercially in thermal insulation for over fifty years.

The amount of IR absorbing and scattering material in the loose fill thermal insulation product can range from 1 to 40 wt %, preferably from 2 to 30 wt %, more preferably from 4 to 20 wt %. If the amount of IR absorbing and scattering material is less than 1 wt %, then the reduction in radiative heat loss is negligible. If the amount of IR absorbing material is in excess of 40 wt %, then the IR absorbing and scattering material forms an undesirable amount of dust, increases the blown density of loose fill, and reduces the coverage of the loose fill thermal insulation product.

The IR absorbing and scattering material preferably comprises particles having a mean diameter in a range of from 2 to 10 μm, more preferably from 3 to 7 μm, most preferably from 3 to 6 μm. Methods of measuring particle size are well known in the art and will not be repeated here.

The loose fill can be in the form of fibers, flakes, powders, granules and/or nodules of various materials. Preferably, the loose fill can be compressed during storage to save space, and then expanded or “fluffed-up” with air or another gas when poured or blown into a hollow wall or other empty space. The loose fill can include both organic and inorganic materials. Examples of organic loose fill material include animal fibers, such as wool; cellulose-containing vegetable fibers, such as cotton, granulated cork (bark of the cork tree) redwood wool (fiberized bark of the redwood tree), and recycled, shredded or ground newspapers; synthetic polymer fibers including cellulosic polymer fibers, such as rayon, and thermoplastic polymer fibers, such as polyester; and expanded plastic beads. Examples of inorganic loose fill material include diatomaceous silica (fossilized skeletons of microscopic organisms), perlite, vermiculite, silica aerogel, calcium silicate, glass fibers, fibrous potassium titanate, alumina-silica fibers, microquartz fibers, opacified colloidal alumina, zirconia fibers, alumina bubbles, zirconia bubbles, carbon fibers, granulated charcoal, cement fibers, graphite fibers, rock fibers, slag fibers, glass wool and rock wool. The loose fill can include one or more varieties of loose fill material. Preferably, the loose fill includes fibers or shredded or ground recycled newspapers.

When compressed during storage, the loose fill particles forming the compressed loose fill are each dimensioned so as to have an equivalent sphere with a diameter generally smaller than 3 cm, preferably from 0.1 to 1 cm. After the compressed loose fill is decompressed, expanded and processed through a blowing hose, the loose fill particles forming the expanded loose fill are each dimensioned so as to just fit within a sphere having a diameter of from 0.1 to 4 cm, preferably from 0.5 to 2 cm.

The thermal insulation product of the present invention can be formed by dispersing, preferably uniformly, the IR absorbing and scattering material in the loose fill before or at the same time as the loose fill is poured or blown into an interior, empty space of a hollow or open object, such as a hollow wall or an attic. Methods of pouring and blowing loose fill are well known in the art and will not be repeated here in detail. Generally, blowing loose fill involves feeding compressed loose fill into a blower where it is mixed with a gas, such as air, expanded, processed through a blowing hose, and then blown into a hollow or open structure to form thermal insulation.

In embodiments, a liquid mixture including a liquid, such as water, and one or more of the IR absorbing and scattering material and a binder (i.e., adhesive), preferably air drying, can be sprayed onto or otherwise mixed with the loose fill before the loose fill is compressed; when the loose fill is decompressed; and/or at the end of the blowing hose before the loose fill is installed in a hollow or open space. The binder serves to join and hold the IR absorbing and scattering material and the loose fill together. The binder can be organic or inorganic. The organic binder can include an organic water based binder such as an acrylic latex or a vinyl acetate latex. The organic binder can also include a sprayed hot melt adhesive such as a thermoplastic polymer. The inorganic binder can include an inorganic bonding agent such as sodium silicate or a hydraulic cement. Evaporation of the liquid from the liquid mixture on the loose fill results in a loose fill thermal insulation product with the IR absorbing and scattering material and/or binder dispersed in the loose fill. In various embodiments, the IR absorbing and scattering material and the binder can be added to the loose fill at the same time or at different times.

A mineral oil can be used instead of or in addition to the binder for the purpose of dust reduction.

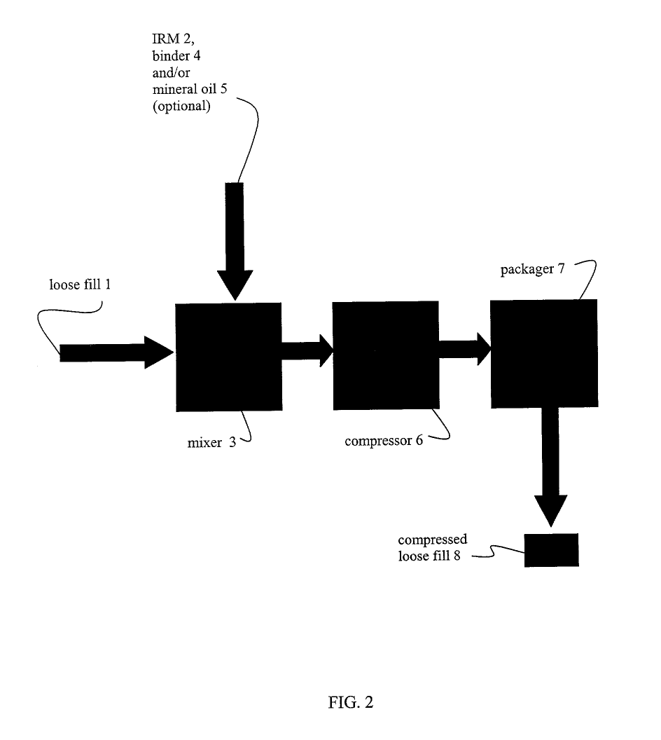

FIG. 2 shows embodiments of the invention in which loose fill 1 is fed along with IR absorbing and scattering material 2 (“IRM 2”) into mixer 3 to form a mixture of loose fill 1 and IRM 2. In embodiments, binder 4 and/or mineral oil 5 can also be mixed in mixer 3 with loose fill 1 and the IRM 2. The mixture is then fed to compressor 6, where the mixture is compressed to remove air and increase density. The compressed mixture is then fed to packager 7, where the compressed mixture is packaged as compressed loose fill 8.

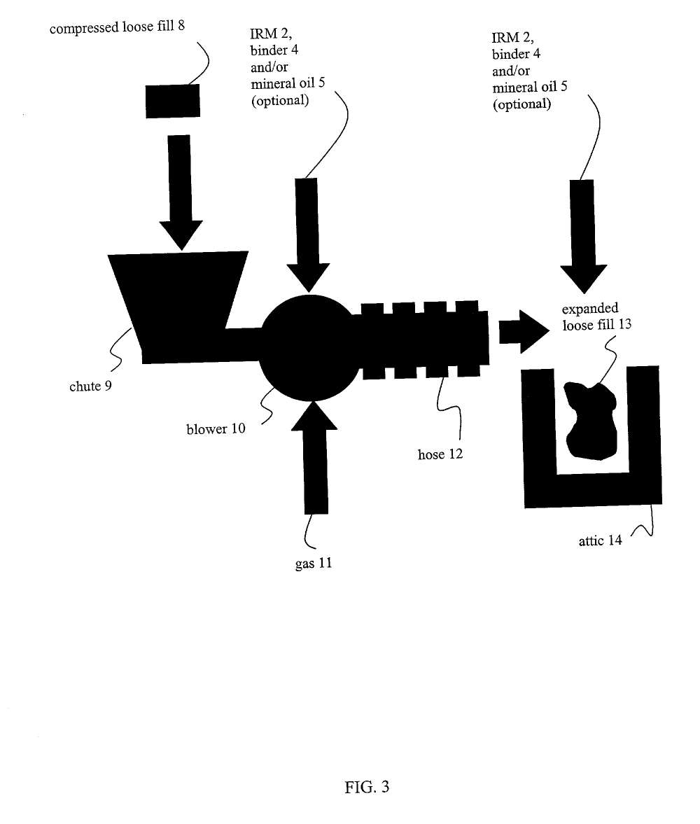

FIG. 3 shows that compressed loose fill 8 can then be fed via a chute or hopper 9 into a blower 10. Blower 10 uses gas 11 to decompress, expand and process the compressed loose fill 8 including the IRM 2 through a corrugated blowing hose 12. From blower 10 expanded loose fill 13 is blown into an open attic 14 to provide thermal insulation. In other embodiments, IRM 2, binder 4 and/or mineral oil 5 is added along with the compressed loose fill 8 to blower 10, and blower 10 both mixes the IRM 2, binder 4 and/or mineral oil 5 with compressed loose fill 8 and expands compressed loose fill 8. In still other embodiments, IRM 2, binder 4 and/or mineral oil 5 is added to expanded loose fill 13 in a liquid spray application injected near the end of the blowing hose 12 or sprayed on the expanded loose fill 13 as it exits the blowing hose 12 and is blown into the open attic 14.

### EXAMPLES

The following non-limiting examples will further illustrate the invention.

### Example 1

Cellulose loose fill, rock wool loose fill, and glass fiber loose fill were each separately mixed with 4 μm mean diameter CaCO₃ particles in a blowing machine. The CaCO₃ particles formed 12% by weight of each mixture. Through a corrugated hose, each mixture of loose fill and CaCO₃ was blown into three 24″×24″−6″ boxes for thermal resistance testing in accordance with ASTM C518 at a mean temperature of 75° F. For comparison cellulose loose fill, rock wool loose fill, and glass fiber loose fill, without added CaCO₃, were blown into three thermal test boxes under the same blowing conditions. The thermal resistance of the test boxes when filled with only the loose fill was compared with the thermal resistance of the test boxes when filled with the mixture of the loose fill and CaCO₃. The results are shown below in Table 1.

TABLE 1

| | | | With 12 wt % Calcium Carbonate | |
|---|---|---|---|---|
| | Without Calcium Carbonate | | (4 μm mean particle size) | |
| Loose | Density | Thermal | Density | Thermal |
| Fill | (lb/ft³) | Conductivity* | (lb/ft³) | Conductivity* |
| Cell- | 1.50 | 0.332 | 1.71 | 0.296 |
| ulose | | | | |
| Rock | 2.90 | 0.288 | 3.30 | 0.268 |
| wool | | | | |
| Glass | 0.350 | 0.434 | 0.398 | 0.405 |
| Fiber | | | | |

*units of Btu.inch/hr.ft².° F.

It was found that adding 12 wt % of 4 μm mean diameter CaCO₃ particles reduced the thermal conductivity and improved the thermal resistance of cellulose loose fill by 10.8%, of rock wool loose fill by 6.9%, and of glass fiber loose fill by 6.7%.

### Example 2

CaCO₃ particles with mean diameters of 3 μm, 5 μm and 9 μm were each separately mixed with cellulose loose fill in a blowing machine. The CaCO₃ formed 12 wt % of each mixture. The mixtures of loose fill and CaCO₃ were each separately blown into one 24″×24″×6″ box. The product density was 1.5 lb/ft3. Thermal conductivity testing in accordance with ASTM C518 was conducted at a mean temperature of 75° F. The results are shown in Table 2.

TABLE 2

| | Density | |
|---|---|---|
| Loose Fill | (lb/ft3) | Thermal Conductivity* |
| Cellulose with 12 wt % CaCO₃ | 1.50 | 0.319 |
| (3 μm mean particle size) | | |
| Cellulose with 12 wt % CaCO₃ | 1.50 | 0.262 |
| (5 μm mean particle size) | | |
| Cellulose with 12 wt % CaCO₃ | 1.50 | 0.362 |
| (9 μm mean particle size) | | |

*units of Btu.inch/hr.ft².° F.

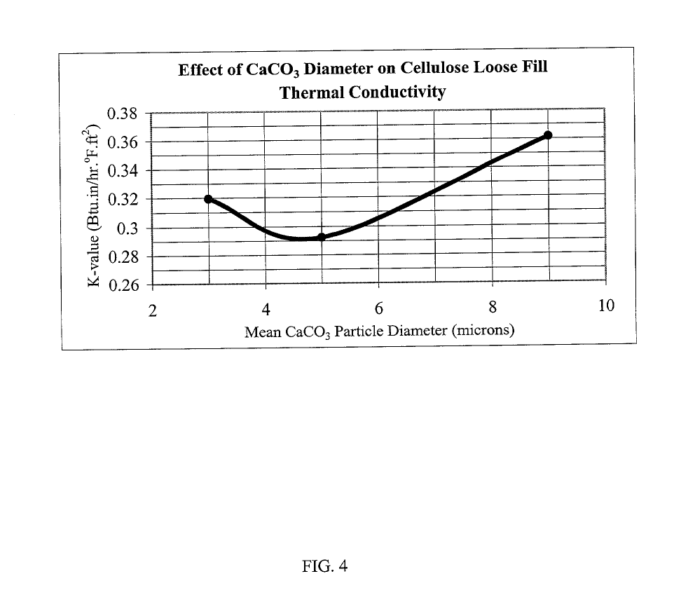

FIG. 4 plots the variation in thermal conductivity with CaCO₃ particle size that is shown in Table 2. FIG. 4 shows that the CaCO₃ particle size providing optimal improvement in reducing thermal conductivity is in the range of about 3.5 μm to about 6 μm.

While the present invention has been described with respect to specific embodiments, it is not confined to the specific details set forth, but includes various changes and modifications that may suggest themselves to those skilled in the art, all falling within the scope of the invention as defined by the following claims.

What is claimed is:

1. A thermal insulation product comprising
a loose fill; and
at least one carbonate dispersed in the loose fill.

2. The product according to claim 1, wherein the loose fill comprises fibers selected from the group consisting of cellulose-containing fibers, synthetic polymer fibers, rock wool fibers, and glass fibers.

3. The product according to claim 1, wherein the loose fill comprises at least one of shredded recycled newspapers and ground recycled newspapers.

4. The product according to claim 1, wherein the at least one carbonate is dispersed uniformly in the loose fill.

5. The product according to claim 1, wherein the product comprises the at least one carbonate in an amount of from 1 to 40% by weight.

6. The product according to claim 1, wherein the at least one carbonate comprises particles having a mean diameter in a range of from 3 to 6 μm.

7. The product according to claim 1, wherein the at least one carbonate comprises calcium carbonate.

8. The product according to claim 1, further comprising a binder joining the at least one carbonate to the loose fill.

9. The product according to claim 1, further comprising a mineral oil dispersed in the loose fill.

10. The product according to claim 1, wherein the at least one carbonate absorbs infrared radiation having a wavelength in a range of 4 to 40 μm.

11. A method of using a thermal insulation product, the method comprising positioning the product of claim 1 in an interior of a hollow or open object.

12. A method of making a thermal insulation product, the method comprising dispersing at least one carbonate in a loose fill.

13. The method according to claim 12, further comprising positioning the loose fill in an interior of a hollow or open object.

14. The method according to claim 13, wherein the positioning comprises pouring or blowing the loose fill into the interior of the hollow or open object.

15. The method according to claim 13, wherein the at least one carbonate is dispersed in the loose fill before the loose fill is positioned in the interior of the hollow or open object.

16. The method according to claim 12, wherein the at least one carbonate is dispersed uniformly in the loose fill.

17. The method according to claim 12, wherein the dispersing comprises
wetting the loose fill with a liquid mixture containing a liquid and the at least one carbonate to form a wet loose fill mixture; and
removing the liquid from the wet loose fill mixture.

18. The method according to claim 17, wherein the liquid is removed from the wet loose fill mixture by air drying.

19. The method according to claim 17, further comprising dispersing a binder in the liquid mixture.

20. The method according to claim 12, further comprising dispersing a binder in the loose fill with the at least one carbonate.

21. The method according to claim 12, further comprising dispersing mineral oil in the loose fill.

22. The method according to claim 12, wherein the at least one carbonate comprises calcium carbonate.

23. The method according to claim 12, wherein the loose fill comprises fibers selected from the group consisting of cellulose-containing fibers, synthetic polymer fibers, rock wool fibers, and glass fibers.

24. The method according to claim 12, wherein the loose fill comprises at least one of shredded recycled newspapers and ground recycled newspapers.
